(19) United States
(12) Patent Application Publication
(10) Pub. No.: US 2012/0084138 A1
(43) Pub. Date: Apr. 5, 2012

(54) ADVERTISEMENT MANAGEMENT

(75) Inventors: Anoop Anantha, Kirkland, WA (US); Murali R. Krishnan, Clyde Hill, WA (US)

(73) Assignee: MICROSOFT CORPORATION, Redmond, WA (US)

(21) Appl. No.: 12/898,131

(22) Filed: Oct. 5, 2010

(51) Int. Cl. G06Q 30/00; H04N 7/025

(52) U.S. Cl. 705/14.41; 725/32; 705/14.69; 705/14.73

(57) ABSTRACT

Advertisement management techniques are described. In one or more implementations, a plurality of identifiers are collected of advertisements communicated to respective ones of a plurality of mobile communication devices, each identifier exposed by a respective mobile communication device at a physical location of a merchant. A monetary amount is calculated to be provided to a service that was involved in providing the one or more advertisements to the mobile communication device.

### BACKGROUND

Mobile communication devices such as wireless phones have become a common part in the everyday life of a wide variety of users. Consequently, the mobile communication device may serve as a primary point of contact for a variety of business and personal uses. For example, a business user may utilize the mobile communication device to receive email, a casual user may send text messages to friends, either one of the users may share pictures, and so on.

However, traditional techniques that were employed to securely store data on the mobile communication device as well as to communicate data to the mobile communication device could result in the data being “in the clear.” Even if but for a brief moment in time, malicious parties may take advantage of this vulnerability to steal sensitive data. This may even result in the ability by the malicious party to access other information on the mobile communication device itself. Consequently, functionality of the mobile communication device may be limited from meeting its true potential due to the ability to compromise data on the mobile communication device.

### SUMMARY

Advertisement management techniques are described. In one or more implementations, a plurality of identifiers are collected of advertisements communicated to respective ones of a plurality of mobile communication devices, each identifier exposed by a respective mobile communication device at a physical location of a merchant. A monetary amount is calculated to be provided to a service that was involved in providing the one or more advertisements to the mobile communication device.

In implementations, a search request is received via an Internet to perform an Internet search. Search results are transmitted to a computing device that originated the request, the search results including an option to cause an advertisement to be communicated to a particular mobile communication device.

In implementations, a mobile communication device comprises one or more modules that are configured to provide telephone functionality including an ability to make and receive telephone calls, communicate credentials to purchase a good or service at a physical location of a merchant that is to provide the good or service, and expose an identifier of an advertisement to the merchant, the identifier usable by the merchant to track that the mobile communication device has visited the physical location of the merchant and has obtained the advertisement.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an example implementation of a mobile communications device in accordance with one or more embodiments of devices, features, and systems for mobile communications.

FIG. 2 is an illustration of a system in an example implementation in which a mobile communication device of FIG. 1 interacts with a merchant to purchase a good or service, the interaction being followed using an advertisement.

FIG. 3 is a flow diagram depicting a procedure in an example implementation in which an advertisement is communicated to a mobile communication device in response to selection of an option.

FIG. 4 is a flow diagram depicting a procedure in an example implementation in which an advertisement is received by a mobile communication device.

FIG. 5 is a flow diagram depicting a procedure in an example implementation in which identifiers of advertisements are collected and used as a basis for a revenue model.

FIG. 6 illustrates various components of an example device that can be implemented in various embodiments as any type of a mobile device to implement embodiments of devices, features, and systems for mobile communications.

### DETAILED DESCRIPTION

Overview

Advertisements are typically used by merchants to promote business. For example, an advertisement may be used to promote name recognition, provide coupons to influence a prospective consumer to visit the merchant, and so on. However, traditional advertising techniques were generally limited in an ability to determine the effectiveness of the advertisement.

Advertisement management techniques are described. In implementations, techniques are described which may help determine effectiveness of an advertisement. For example, a user may receive a webpage having an option to have an advertisement (e.g., a coupon) communicated to a wireless phone. The wireless phone may then be taken to a physical location of a merchant that corresponds to the advertisement.

The advertisement, stored on the mobile communication device, may be detected by the merchant, such as by scanning an image using a kiosk, use of the advertisement in a purchase, communicated wirelessly using near field technology, and so on. In this way, the merchant may be able to detect that the advertisement was successful in getting a prospective consumer to the physical location, regardless of whether the advertisement (e.g., the coupon) was used. Thus, the merchant may be able to track the effectiveness of the advertisement, even for purchases of goods or services that were not involved in the advertisement and provide remuneration to a service involved in getting the advertisement to the prospective consumer, such as a search service, periodical publisher, television broadcaster, and so on.

Further, these techniques may also be used as a basis of a revenue system. For example, this advertising model may be monetized based at least in part on a “cost per visit.” Thus, a merchant may have a direct correlation between a cost and a desired result, such as to get prospective consumers to visit the physical location of the merchant. These techniques may be leveraged to support a variety of other features, further discussion of which may be found in relation to the following figures.

In the following discussion, a variety of example implementations of a mobile communication device (e.g., a wireless phone) are described. Additionally, a variety of different functionality that may be employed by the mobile communication device is described for each example, which may be implemented in that example as well as in other described examples. Accordingly, example implementations are illustrated of a few of a variety of contemplated implementations. Further, although a mobile communication device having one or more modules that are configured to provide telephonic functionality are described, a variety of other mobile devices are also contemplated, such as personal digital assistants, mobile music players, dedicated messaging devices, portable game devices, netbooks, and so on.

Example Implementations

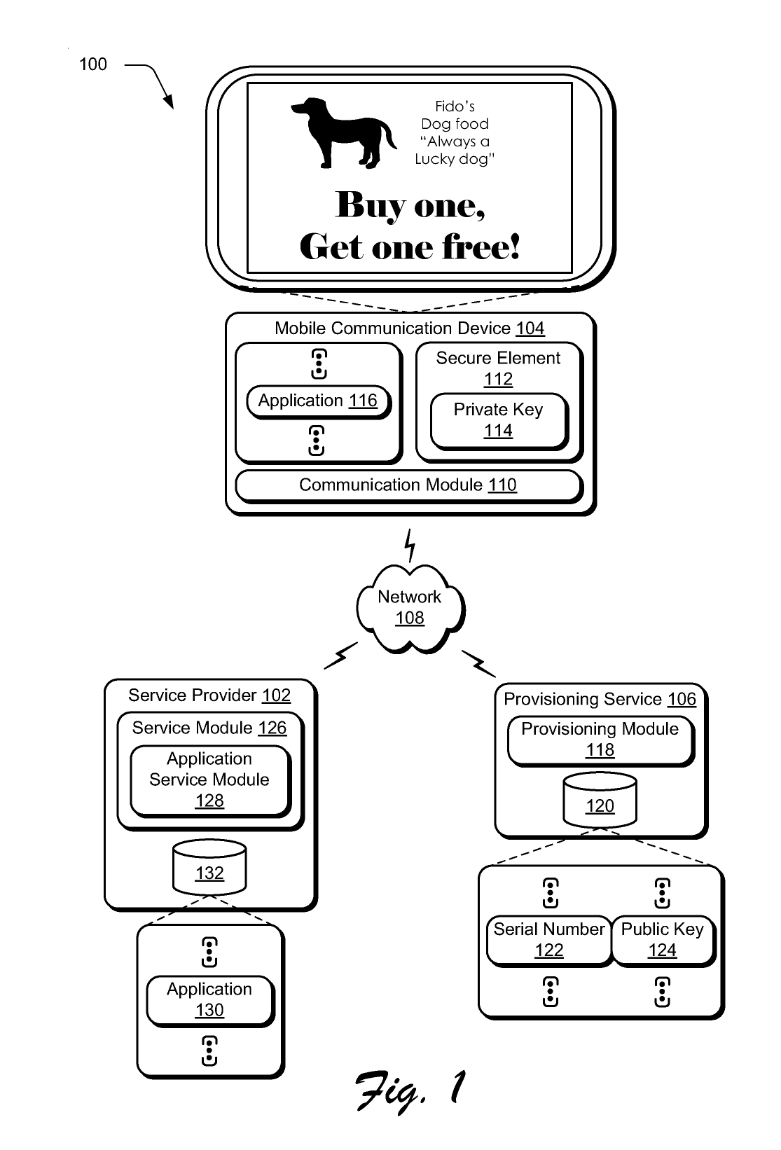

FIG. 1 is an illustration of an example implementation of an environment 100 that is operable to employ the techniques described herein. The environment includes a service provider 102, a mobile communication device 104, and a provisioning service 106 that are illustrated as communicatively coupled, one to another, via a network 108. Although the network 108 is illustrated as the Internet, the network may assume a wide variety of configurations. For example, the network 108 may include a wide area network (WAN), a local area network (LAN), a wireless network, a public telephone network, an intranet, and so on. Further, although a single network 108 is shown, the network 108 may be representative of multiple networks.

The mobile communication device 102 is further illustrated as including a communication module 110. The communication module 110 is representative of functionality of the mobile communication device 102 to communicate via the network 108. For example, the communication module 110 may include telephone functionality to make and receive telephone calls, such as by employing a telephone module to communicate via a plain old telephone service (POTS), wireless network (e.g., cellular and/or Wi-Fi), and so on.

The communication module 110 may also include a variety of other functionality, such as to capture content, form short message service (SMS) text messages, multimedia messaging service (MMS) messages, emails, status updates to be communicated via a social network service or micro-blog, and so on. For instance, the communication module 110 may also support browser functionality to browse the network 108.

The mobile communication device 104 is further illustrated as including a secure element 112. In one or more implementations, the secure element 112 is representative of functionality to support secure communications with the mobile communication device 104. The secure element 112 may be implemented using hardware and configured during manufacture to include a private key 114. For instance, the secure element 112 may be implemented using a tamper-resistant integrated circuit that is resistant to “snooping” as well as physical removal from the mobile communication device 104 by a manufacturer of the device. The manufacturer may cover a surface-mounted integrated circuit with an epoxy that helps to prevent snooping of the circuit as well as causing the circuit to break if removal is attempted.

In implementations, the secure element 112 includes functionality to perform encryption and/or decryption operations. For example, the secure element 112 may use the private key 114 to perform a decryption operation and expose a result of the operation to other functionality of the mobile communication device 104, such as to one or more applications 116 that are executable by the mobile communication device 104. In this example, the secure element 112 may receive data to be decrypted from the application 116, decrypt the data using the private key 114, and then expose a result of the decryption operation (i.e., the decrypted data) to the application 116. Therefore, inclusion of the private key 114 in the secure element 112 may help to protect the private key 114 from discovery “outside” the secure element 112 by keeping the private key 114 from being exposed “in the clear” during the decryption operation.

A variety of other functionality may also be supported through use of the secure element 112. For example, the secure element 112 may support a protected communication channel through the provisioning service 106. The provisioning service 106, for instance, may include a provisioning module 118 and storage 120. The storage 120 may be used to maintain a serial number 122 assigned to an integrated circuit that includes the secure element 112 and a corresponding public key 124 that forms an asymmetric public/private key pair with the private key 114 of the mobile communication device 104. The provisioning module 118 may thus provide the public key 124 to third-party services such that communication between the third-party service and the mobile communication device 104 is protected, even if that communication occurs using the provisioning service 106 or other service as an intermediary.

For example, a user of the mobile communication device 104 may interact with the communication module 110 or other functionality (e.g., an application 116) to navigate to a service provider 102 over the network 108. The service provider 102 as illustrated includes a service module 126 that is representative of functionality to provide one or more services for access via the network 108.

An example of one of these services is illustrated as implemented by an application service module 128. The application service module 128 is representative of functionality to manage dissemination of one or more applications 130 via the network 108. Although the applications 130 are illustrated as stored in storage 132 local to the service provider 102 (e.g., as part of a server farm that implements the service provider 102), the storage 132 may be representative of a wide variety of different types of storage, e.g., third party storage.

In an example, the application service module 138 manages a marketplace configured to provide applications 130 for purchase via the network 108. Therefore, a user of the mobile communication device 104 may access the marketplace to purchase one or more of the applications 130 for download to local storage, which is illustrated as application 116 in this example. To purchase and/or transport the application 130, the mobile communication device 104 and the service provider 102 may utilize secure communications implemented at least in part through use of the secure element 112. The secure communications may be implemented in a variety of ways.

In one instance, the public key 124 is provided to secure communications between the service provider 102 and the mobile communication device 104 directly. For example, the public key 124 may be located by the provisioning module 118 of the provisioning service 106 by obtaining a serial number 122 for the integrated circuit that implements the secure element 112, e.g., from the mobile communication device 104. The provisioning module 118 may then use the serial number 122 to locate the public key 124 and provide the public key 124 to the service provider 102. The public key 124 may then be used to encrypt data to be communicated to the mobile communication device 104, such as the application 130, billing information and other credentials, and so on.

In another instance, the provisioning service 106 provides the public key 124 to the service provider 102 as a basis to support indirect communications, such as to securely transport credentials and other data (e.g., cryptographic keys) that are to be used as a basis to form a communication channel. For example, the service provider 102 may provide credentials (e.g., other cryptographic keys) that are to be used to secure communications between the service provider 102 and the mobile communication device 104. To protect these credentials from compromise by malicious parties, the credentials may be encoded using this public key 124. In other words, the other cryptographic keys may be encrypted using the public key 124 for communication to the mobile communication device 104 to protect the other cryptographic keys from discovery by malicious parties.

In this way, regardless of whether the communication is communicated indirectly via the provisioning service 106 or directly via the network 108, the credentials (e.g., the other cryptographic keys) are protected from discovery through encryption using the public key 124. Therefore, even the provisioning service 106 itself is not able to determine “what” is being communicated between the service provider 102 and the mobile communication device 104.

The mobile communication device 104 may then decrypt the communication using the secure element 112, and more particularly the private key 114, to obtain the other cryptographic keys. A variety of different techniques may then be employed to utilize the other cryptographic keys once decrypted. In one technique, the other cryptographic keys are exposed for use outside the secure element 112, such as by an application 116 or other functionality of the mobile communication device 104. These techniques the secure element 112 is leveraged to provide the credentials that are used to serve as a basis to secure communications but is not used to secure the communications itself, i.e., to provide the actual encryption/decryption.

In another technique, the other cryptographic keys may be kept from being exposed outside the secure element 112 through storage within the secure element 112. The secure element 112 may then use the cryptographic keys as previously described to decrypt and/or encrypt data received by the secure element 112 without exposing the cryptographic keys “outside” the secure element 112. The secure element 112 may thus employ a variety of different techniques to secure communications with the mobile communication device 104, the example of the service provider 102 above being but one of many such examples.

The secure element 112 may be leveraged to provide a variety of different functionality. For example, the secure element 112 may be used as a basis to implement an “electronic wallet” to purchase goods or services. The electronic wallet, for instance, may maintain credentials (e.g., credit card information, user name and password, and so on) via the secure element to purchase goods or services. During this purchase, the wallet may also provide one or more advertisements that may be used in the transaction, such as a coupon. Thus, the wallet in this example may be used to automatically provide relevant advertisements to a merchant, such as based on a merchant identifier or location of the transaction, analysis of which advertisement might be valid for a particular transaction, and so on.

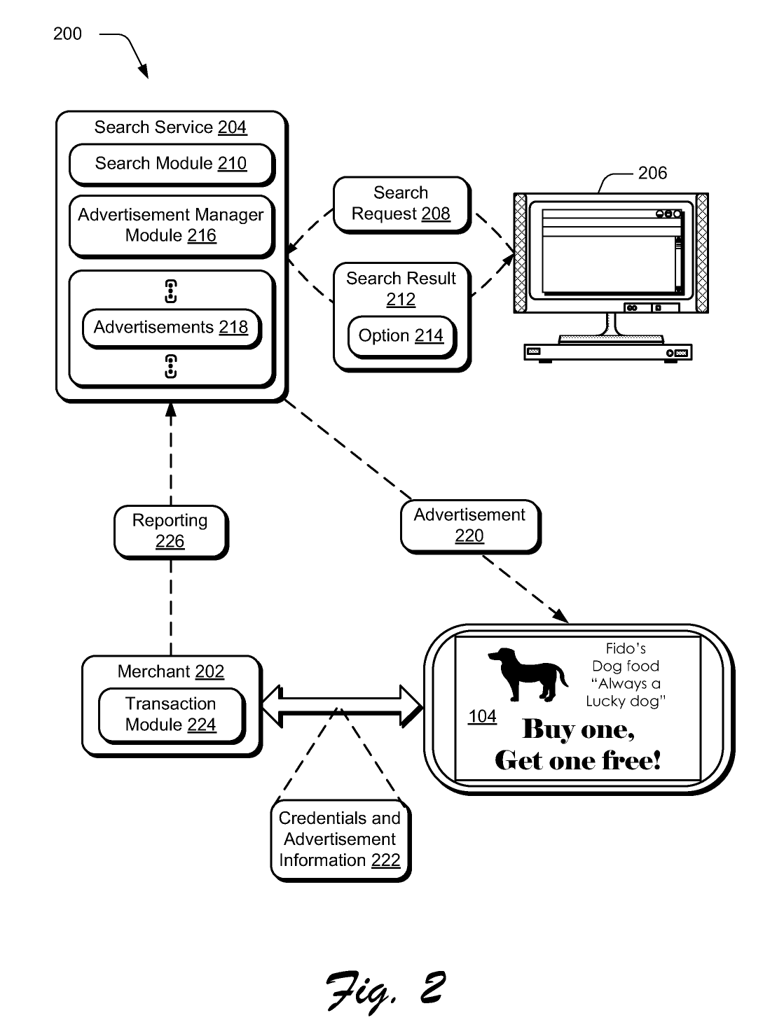

Further, the advertisements maintained by the mobile communication device 104 may also serve as a basis to “close an advertising loop.” For instance, the advertisement may be used to determine that a prospective consumer visited the physical premises of a merchant. Additionally, this determination may be performed even if the advertisement was not used to perform a transaction, further discussion of which may be found beginning in relation to FIG. 2.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof In the case of a software implementation, the module, functionality, or logic represents program code that performs specified tasks when executed on a processor (e.g., CPU or CPUs). The program code can be stored in one or more computer readable memory devices, such as random access memory, read only memory, hard disk drives, optical discs, flash drives, and so on. The features of the advertisement management techniques described below are platform-independent, meaning that the techniques may be implemented on a variety of commercial computing platforms having a variety of processors.

FIG. 2 depicts a system 200 in an example implementation in which a mobile communication device 104 interacts with a merchant to purchase a good or service and provide an advertisement that is used to track effectiveness of the advertisement. The system 200 of FIG. 2 includes the mobile communication device 104 of FIG. 1 as well as a merchant 202, a search service 204, and another computing device 206.

In this example, a user interacts with the computing device 206 to perform a web search, such as by using a browser, although other examples are also contemplated, e.g., to provide display ads in addition to search adds in which case a search request is not provided. In response, a search request 208 is communicated over the Internet to a search service 204, which may include one or more search terms. A search module 210 of the search service 204 may then process the search request 208 to arrive at a search result 212 that is communicated back to the computing device 206 over the Internet.

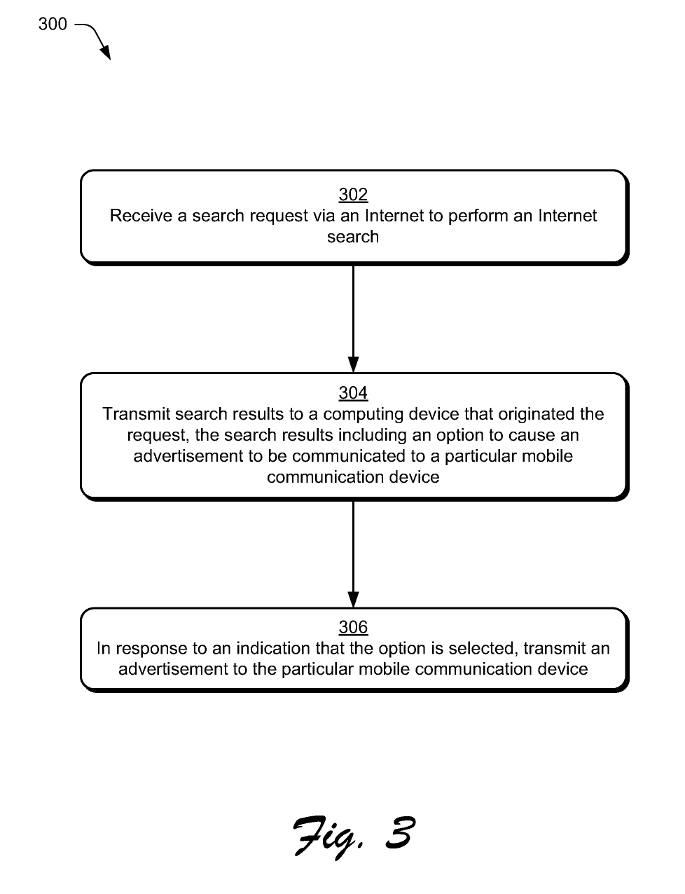

However, in this example, the search result 212 includes an option 214. The option 214 is selectable to cause an advertisement manager module 216 of the search service 204 to communicate one or more advertisements 218 to the mobile communication device 104. The option 214, for instance, may include a “clickable” button, text input box, and so on that is configured to identify the particular mobile communication device 104, such as a phone number, email address, and so on. Further, the advertisement that is communicated may be chosen to have relevance based on the search results, and thus the search functionality may be leveraged to chose an advertisement that is likely applicable to a user of the mobile communication device 104. A variety of other options are also contemplated including automatic communication based on stored user information, further discussion of which may be found in relation to FIG. 3.

The advertisement 220 is thus communicated and stored on the mobile communication device, after which a user may visit the physical premises of a merchant 202, e.g., a store, retail outlet, and other “bricks and mortar” locations. Once there, the mobile communication device 104 may be utilized to initiate a transaction to purchase a good or service, such as by using the electronic wallet functionality previously described in relation to FIG. 1.

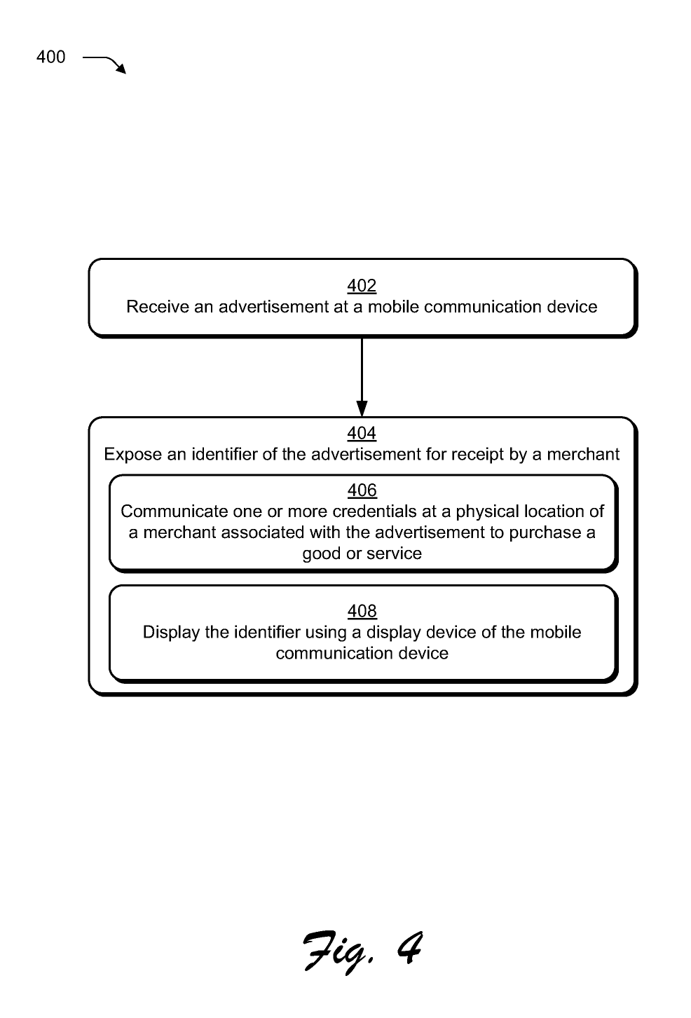

Additionally, this functionality may be used to communicate a relevant advertisement that may be used in the transaction. This is illustrated in FIG. 2 through communication of credentials and advertisement information 222 between the mobile communication device 104 and the merchant 202. This communication may be performed in a variety of ways, such as by using near field technology, display of a code by the mobile communication device 104 that is configured to be scanned (e.g., a barcode), and so on, further discussion of which may be found in relation to FIG. 4.

The merchant 202 is illustrated in this system 200 as including a transaction module 224. The transaction module 224 is representative of functionality to process the transaction using the credentials received from the mobile communication device 104. For example, the transaction module 224 may process credit card information that is provisioned in the secure element 112 of the mobile communication device using the techniques described in relation to FIG. 1 in relation to the provisioning service 106.

The transaction module 224 may also process the advertisement information. For example, the transaction module 224 may be configured to provide reporting 226 that describes that the advertisement 220 was physically taken to the merchant 202. Thus, the merchant 202 is aware that the advertisement 220 was successful in bringing in “foot traffic,” which may serve as a basis of a cost-per-visit (CPV) revenue model for an advertiser.

The advertisement 220 may also serve to track other user behavior. For example, the advertisement 220 may serve as a basis to track other purchases made by the mobile communication device 104, even if the purchases do not correspond to the advertisement. For instance, the advertisement may involve a buy one/get one free offer for dog food as illustrated as displayed by the mobile communication device 104. Even if the user of the mobile communication device 104 does not purchase the dog food, the presence of the advertisement 220 may be detected. In this way, the merchant 202 may determine that the advertisement 220 was successful at getting a prospective customer “through the door,” such as to purchase other goods and services even if those other goods and services were not directly involved with the offer. Other functionality is also contemplated, such as to model user preferences, further discussion of which may be found in relation to the following procedures.

Example Procedures

The following discussion describes advertisement techniques that may be implemented utilizing the previously described systems and devices. Aspects of each of the procedures may be implemented in hardware, firmware, software, or a combination thereof The procedures are shown as a set of blocks that specify operations performed by one or more devices and are not necessarily limited to the orders shown for performing the operations by the respective blocks. In portions of the following discussion, reference will be made to the environment 100 and system 200 of FIGS. 1 and 2, respectively.

FIG. 3 depicts a procedure 300 in an example implementation in which an advertisement is communicated to a mobile communication device in response to selection of an option. A search request is received via an Internet to perform an Internet search (block 302). For example, a user may interact with the computing device 206 and use a browser to navigate over a network to the search service 204. The search service 204 may then employ one or more search techniques to generate results for the search request 208.

Search results are transmitted to a computing device that originated the request, the search results including an option to cause an advertisement to be communicated to a particular mobile communication device (block 304). Continuing with the previous example, the search result 212 may be communicated back to the computing device 206. The search result 212 may include an option that is selectable to cause an advertisement 220 to be communicated to the mobile communication device 104.

The option, for example, may be included in an advertisement in a webpage that includes the search result 212. The option 214 may include functionality to indicate a particular mobile communication device that is to receive the advertisement 220, such as an email address, telephone number, and so on.

In response to an indication that the option is selected, an advertisement is transmitted to the particular mobile communication device (block 306). Upon providing the information described, the advertisement 220 may be communicated to the mobile communication device 104, such as over the Internet using Wi-Fi and/or a cellular telephone connection, and so on. Although the advertisement was provided responsive to selection of an option in a search result, the advertisement may be stored on the mobile communication device in a variety of other ways.

A television program, for instance, may include an option that may be scanned by the mobile communication device 104 by taking a photo of the television. In this way, the television may be used to communicate the advertisement to the mobile communication device 104. In another instance, a kiosk may be used to communicate the advertisement to the mobile communication device, such as using a near field technology, scanning using a camera of the mobile communication device, and so on. A variety of other examples are also contemplated without departing from the spirit and scope thereof, such as by taking a picture of a poster of other image by the mobile communication device 104, the image including an identifier such as a barcode, use of stored user preferences (e.g., which may allow a user to “opt in” to have advertisements sent to a particular mobile communication device), and so on. 100511 FIG. 4 depicts a procedure 400 in an example implementation in which an advertisement is received by a mobile communication device. An advertisement is received by a mobile communication device (block 402). The advertisement may be received in a variety of ways, such as in response to selection of an option as described in relation to FIG. 3, by taking a photograph of an image on a television set, from a kiosk, and so on.

An identifier of the advertisement is exposed by the mobile communication device for receipt by a merchant (block 404). The identifier may be a numerical identify, barcode, the advertisement itself, and so on. Consequently, the identifier may be exposed in a variety of ways, such as via near field technology, via display by a display device of the mobile communication device 104 (e.g., displaying a barcode), and so on.

One or more credentials are communicated at a physical location of the merchant associated with the advertisement to purchase a good or service (block 406). As previously described in relation to FIG. 1, the mobile communication device 104 may include functionality of an “electronic wallet” to purchase goods or services. For instance, the mobile communication device 104 may communicate credit card information or other credentials to a merchant 202 to initiate a purchase. As a part of this communication of credentials, the identifier may be communicated, such as a unique code that is assigned to the advertisement. In another instance, the identifier is displayed using a display device of the mobile communication device (block 408). A variety of other instances are also contemplated.

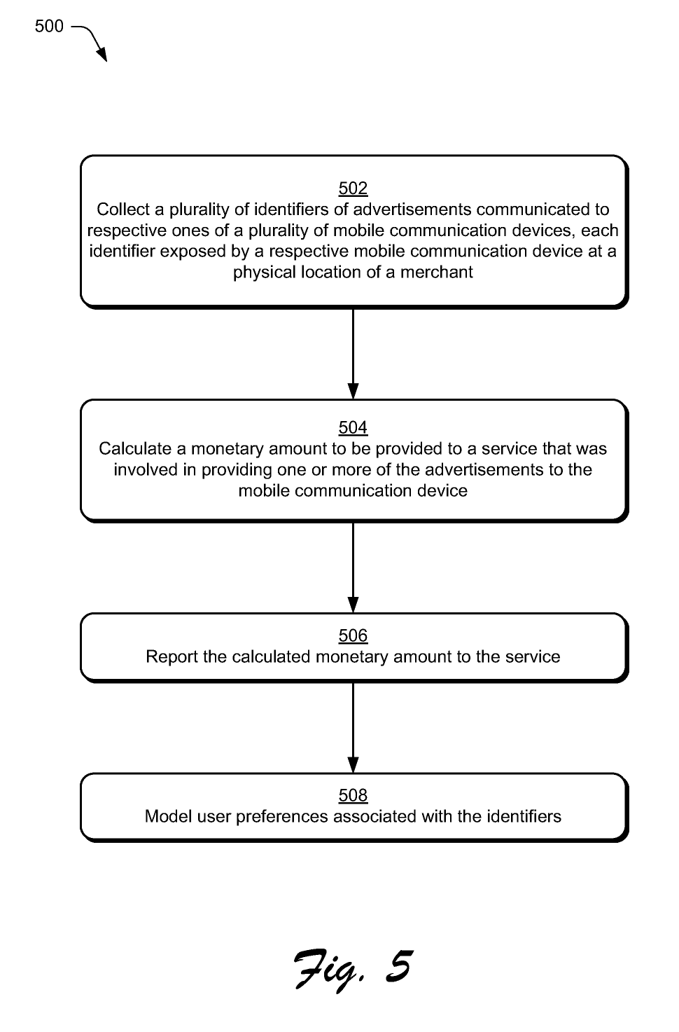

FIG. 5 depicts a procedure 500 in an example implementation in which identifier of advertisements are collected and used as a basis for a revenue model. A plurality of identifiers of advertisements are collected, the advertisements communicated to respective ones of a plurality of mobile communication devices, each identifier exposed by a respective mobile communication device at a physical location of a merchant (block 502). For example, a service may be configured to operate as a central clearinghouse to process communications from a plurality of different merchants. Each of these communications may include identifiers and transaction information that may be used to track effectiveness of the advertisements.

A monetary amount is calculated that is to be provided to a service that was involved in providing the one or more advertisements to the mobile communication device (block 504). Continuing with the previous example, the clearinghouse may compute a monetary amount to pay to a service that was involved in providing the advertisement, such as a search service 204 as described in relation to FIG. 2, a network broadcaster (e.g., as a television example above), or anyone else that was involved in getting the advertisement to a prospective consumer. This may be used to support a variety of different revenue models, such as a cost-per-visit (CPV) model in which an amount is awarded for each verified visit by a prospective consumer to a physical location of a merchant. The calculated monetary amount may then be reported to the service (block 506). The information obtained by the clearinghouse in this example may also be used to support for a variety of other functionality.

For example, user preferences associated with the identifiers are modeled (block 508). The identifier of the advertisement, for instance, may be used to uniquely identify prospective consumers that receive a particular advertisement. Accordingly, the identifier may be used to track what actions were undertaken by the prospective users once the identifier is captured. The identifier, for instance, may be used to track whether the prospective consumer bought a good or service mentioned in the advertisement, whether the consumer bought a different good or service, whether the consumer visited a physical location of a merchant, and so on. These actions may then be modeled to calculate a relative effectiveness of an advertisement on prospective consumers, such as to mimic this advertisement in the future since it was effect in increasing foot traffic, purchases of particular goods or services, and so on. Further, the use of the identifier of the advertisement may function to keep the user itself confidential as the identifier may be used to identify the advertisement and subsequent actions without using a name, phone number, and so on of the user or the user's mobile communication device.

Example Device

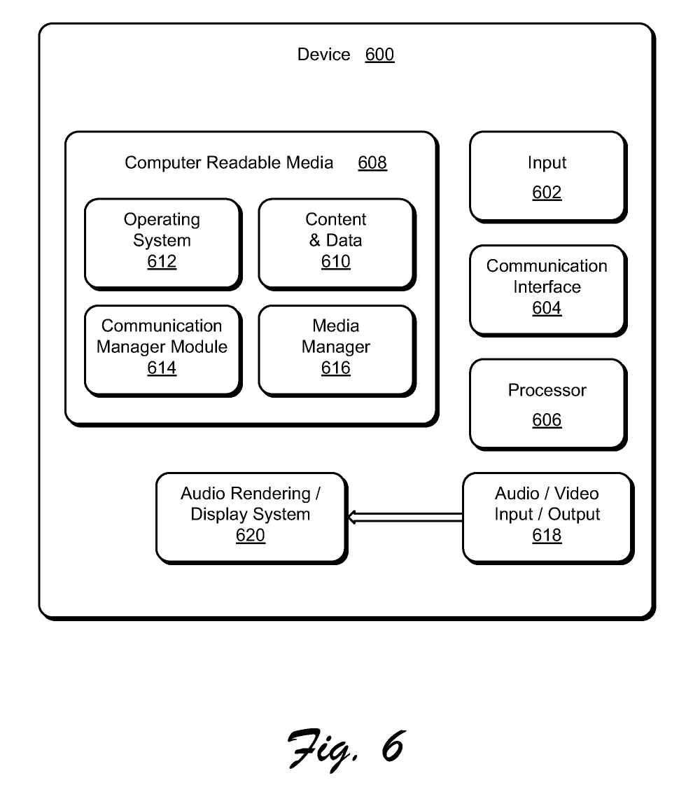

FIG. 6 illustrates various components of an example device 600 that can be implemented in various embodiments as any type of a mobile device to implement embodiments of devices, features, and systems for mobile communications. For example, device 600 can be implemented as any of the mobile communications devices 102 described with reference to respective FIGS. 1-2. Device 600 can also be implemented to access a network-based service, such as a social network service as previously described.

Device 600 includes input 602 that may include Internet Protocol (IP) inputs as well as other input devices, such as the keyboard 112 of FIG. 1. Device 600 further includes communication interface 604 that can be implemented as any one or more of a wireless interface, any type of network interface, and as any other type of communication interface. A network interface provides a connection between device 600 and a communication network by which other electronic and computing devices can communicate data with device 600. A wireless interface enables device 600 to operate as a mobile device for wireless communications.

Device 600 also includes one or more processors 606 (e.g., any of microprocessors, controllers, and the like) which process various computer-executable instructions to control the operation of device 600 and to communicate with other electronic devices. Device 600 can be implemented with computer-readable media 608, such as one or more memory components, examples of which include random access memory (RAM) and non-volatile memory (e.g., any one or more of a read-only memory (ROM), flash memory, EPROM, EEPROM, etc.).

Computer-readable media 608 provides data storage to store content and data 610, as well as device applications and any other types of information and/or data related to operational aspects of device 600. For example, an operating system 612 can be maintained as a computer application with the computer-readable media 608 and executed on processor 606. Device applications can also include a communication manager module 614 (which may be used to provide telephonic functionality) and a media manager 616.

Device 600 also includes an audio and/or video output 618 that provides audio and/or video data to an audio rendering and/or display system 620. The audio rendering and/or display system 620 can be implemented as integrated component(s) of the example device 600, and can include any components that process, display, and/or otherwise render audio, video, and image data. Device 600 can also be implemented to provide a user tactile feedback, such as vibrate and haptics.

Generally, the blocks may be representative of modules that are configured to provide represented functionality. Further, any of the functions described herein can be implemented using software, firmware (e.g., fixed logic circuitry), manual processing, or a combination of these implementations. The terms “module,” “functionality,” and “logic” as used herein generally represent software, firmware, hardware or a combination thereof In the case of a software implementation, the module, functionality, or logic represents program code that performs specified tasks when executed on a processor (e.g., CPU or CPUs). The program code can be stored in one or more computer readable memory devices. The features of the techniques described above are platform-independent, meaning that the techniques may be implemented on a variety of commercial computing platforms having a variety of processors.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by one or more servers, the method comprising:
collecting a plurality of identifiers of advertisements communicated to respective ones of a plurality of mobile communication devices, each said identifier exposed by a respective said mobile communication device at a physical location of a merchant; and
calculating a monetary amount to be provided to a service that was involved in providing the one or more said advertisements to the mobile communication device.

2. A method as described in claim 1, wherein at least one said advertisement was communicated to the mobile communication device responsive to selection of an option in a webpage to cause the communication.

3. A method as described in claim 2, wherein the webpage is displayed and the option is selected using a computing device that is not the mobile communication device.

4. A method as described in claim 1, wherein at least one said advertisement was communicated to the mobile communication device from a kiosk.

5. A method as described in claim 1, wherein at least one said advertisement is communicated to a respective said mobile communication device via a television.

6. A method as described in claim 1, wherein at least one said identifier is exposed by the respective said mobile communication device through display of the identifier by a display device of the mobile communication device at the physical location of the merchant.

7. A method as described in claim 1, wherein at least one said identifier is exposed by the respective said mobile communication device using near field technology.

8. A method as described in claim 1, wherein the service is configured to provide search results over an Internet.

9. A method as described in claim 1, wherein the monetary amount is calculated at least in part to reflect a cost-per-visit.

10. A method as described in claim 9, wherein the cost-per-visit is calculated to provide remuneration regardless of whether the advertisements resulted in a purchase of a good or service from the merchant.

11. A method implemented by one or more servers of a search service, the method comprising:
receiving a search request via an Internet to perform an Internet search; and
transmitting search results to a computing device that originated the request, the search results including an option to cause an advertisement to be communicated to a particular mobile communication device.

12. A method as described in claim 11, wherein the option includes a feature to identify the particular mobile communication device that is to receive the advertisement.

13. A method as described in claim 12, wherein the feature to identify the particular mobile communication device is a telephone number of the mobile communication device.

14. A method as described in claim 11, wherein the advertisement includes an identifier that is usable to track whether the advertisement was successful in getting a user of the mobile communication device to a physical location of a merchant that corresponds to the advertisement.

15. A method as described in claim 11, further comprising receiving an indication of a monetary amount that is to be provided to the search service from advertisers that provided the advertisement.

16. A method as described in claim 11, further comprising receiving an indication of a monetary amount that is to be provided to the search service from one or more merchants that corresponds to the advertisement for a visit by the mobile communication device to a physical location of the one or more merchants.

17. A method as described in claim 11, further comprising modeling user preferences based on transactions performed in conjunction with one or more merchants that correspond to the advertisements that are tracked using an identifier included in the advertisement.

18. A mobile communication device comprising one or more modules that are configured to:
provide telephone functionality including an ability to make and receive telephone calls;
communicate credentials to purchase a good or service at a physical location of a merchant that is to provide the good or service; and
expose an identifier of an advertisement to the merchant, the identifier usable by the merchant to track that the mobile communication device has visited the physical location of the merchant and has obtained the advertisement.

19. A mobile communication device of claim 18, wherein the identifier of the advertisement is usable by the merchant to track purchases made using the mobile communication device regardless of whether the advertisement was applied to the purchases.

20. A mobile communication device of claim 18, wherein the credentials include credit card information that is provisioned on the mobile communication device using a secure element implemented in hardware.
